(19) United States
(12) Patent Application Publication
(10) Pub. No.: US 2002/0022143 A1
(43) Pub. Date: Feb. 21, 2002

(54) Separable adhesive layer, laminate and method for making same

(76) Inventors: Peter Ludwig, Raubling (DE); Wilhelm Munninger, Neubeuern (DE); Werner Tschenet, Raubling (DE)

Correspondence Address: GALGANO & BURKE, 300 Rabro Drive, Hauppauge, NY, 11788, US

(21) Appl. No.: 09/892,395

(22) Filed: Jun. 27, 2001

(30) Foreign Application Priority Data
Jun. 30, 2000 (DE) 100 31 909.2

(51) Int. Cl. B32B 23/08; B32B 27/08; B32B 27/10

(52) U.S. Cl. 428/513; 428/412; 428/483; 428/518; 428/220; 156/244.11; 156/309.6

(57) ABSTRACT

A separable adhesive layer made by extrusion lamination including a mixture of silicone-modified polyethylene and adhesive polyolefin. In the laminate, a backing layer and a top layer are laminated together therewith. The laminate is produced either by broad-slot monoextrusion or broad-slot coextrusion of the adhesive.

### BACKGROUND OF THE INVENTION

The invention relates to a separable adhesive layer, to a laminate and to a method for making same.

Separable adhesive layers are used to secure cards such as check cards, credit cards, club membership cards or chip cards to a backing made of paper, cardboard or plastic. A further area of application for a separable adhesive layer is lamination of a cling vinyl film onto a backing. The term “cling vinyl film” stands for an adhesive-free film which has been internally plasticized and thereby is self-adhesive, and which in printed form is attached to truck surfaces, for example, for advertising purposes.

To simplify the terminology, the object which is to be secured by a separable adhesive layer to a backing will be referred to hereinafter as the information carrier. The following requirements are imposed on the separable adhesive layer:

The adhesive must create, between information carrier and backing, a permanent composite bond which safely withstands further processing and distribution, is insensitive to climatic fluctuations and is aging-resistant.

It must be possible to detach the information carrier from the backing in a manner that is simple, convenient and guaranteed not to cause damage. Adhesive residues must not remain on the information carrier.

The backing surface must no longer be tacky after detachment of the information carrier. The backing is often inserted into a file, and must not stick to it.

Pertinent separable adhesives are known in the literature as peelable glues. They are pressure-sensitive adhesives with low surface tackiness, especially polyacrylate solutions or dispersions, which may be partly cross-linked, and hot-melt adhesives, which bond firmly to the backing, which is usually made of paper, and can be peeled off from the back side of the information carrier, which is relatively resistant to splitting. The known adhesives do not always meet the cited requirements profile to a completely satisfactory degree.

### SUMMARY OF THE INVENTION

The object of the invention is to provide a separable adhesive layer that is improved in the foregoing respect.

The achievement of this object is seen in a separable adhesive layer which is formed by extrusion lamination and which comprises a mixture of silicone-modified polyethylene and adhesive polyolefin.

The general customary term “silicone” used here stands chemically for polydimethylsiloxane (PDMS).

Conventional adhesives for extrusion lamination are tacky when they arrive as a melt film on the substrate. They normally create a permanent adhesive bond and, after cooling, do not have any surface tackiness.

The special feature of the invention is the production of a separable adhesive layer by extrusion lamination, wherein extrusion polymers with mutually conflicting properties—silicone-modified polyethylene having release or “anti-adhesive” properties on the one hand and adhesive polyolefin on the other hand—are used in well-defined mixtures. Therewith the silicone-modified polyethylene originally designed as separating medium is used for the first time for lamination, and for this purpose is mixed in a specific ratio with adhesive polyolefin.

In a preferred embodiment, the modified polyethylene is LD polyethylene (low-density polyethylene).

In a preferred embodiment, the polyethylene is grafted with the silicone. A possible material is the silicone-grafted LD polyethylene LUBOTHENE RLF-4003 of Optatech Corporation.

The polyethylene may also be mixed with the silicone.

The inventive separable adhesive layer either can be monoextruded or can also be coextruded with polyolefin, preferably LD polyethylene.

The subject matter of the invention is also a laminate with a backing layer and a top layer, which are laminated together with an adhesive layer of the said type extruded therebetween.

A monoextruded adhesive layer is homogeneous. Its adhesion to the backing layer and top layer depends on the choice of material therefor.

For practical purposes the backing layer can be regarded as the upper layer of the backing on which the information carrier is to be fixed detachably, and the top layer can be regarded as the lower layer of the information carrier. The backing layer is preferably made of paper and the top layer is preferably made of special paper which is resistant to surface splitting or plastic-coated paper or plastic film. The inventive adhesive has considerably stronger bonding to the backing layer than to the top layer.

The monoextruded adhesive layer preferably has a thickness of 10 to 40μ.

Coextrusion of the inventive adhesive layer is recommended for critical backing layers such as high-density, smooth papers, plastic-coated papers or plastic films. The coextruded material comprises a thick base layer of polyolefin, especially LD polyethylene, which faces the backing layer, and a thin layer of inventive adhesive, which faces the top layer. This layer structure of the coextruded material ensures that bonding to backing layer and top layer can be differentially adjusted and precisely controlled. The composite bond is durably stable.

Manufacturing-related advantages for coextrusion exist in the possibility of different temperature programs for the two melts. The temperature of the LD polyethylene melt is preferably about 280° C. and the temperature of the adhesive melt is preferably not higher than about 220° C.

Material costs can be saved with coextrusion. LD polyethylene is considerably more cost-effective than the inventive adhesive comprising silicone-modified polyethylene and adhesive polyolefin.

Compared with the conventional lamination procedures with adhesive solutions or dispersions, extrusion lamination (monoextrusion or coextrusion) with the inventive adhesive is more cost-effective.

Distribution and processing of LD PE granules and silicone-modified LD PE granules are considerably less expensive and considerably simpler.

Operation with broader material webs and higher machine speeds is possible during extrusion lamination.

Extrusion lamination is environmentally friendly. It does not require solvents and dispersions, and so the environmental problems associated with drying and evaporation of organic solvents and with disposal of adhesive residues and washing fluids do not occur.

The polyolefin base layer in the coextruded material preferably has a thickness of 10 to 30μ. The thickness of the adhesive layer is preferably 1 to 10μ.

In the inventive adhesive, the silicone proportion of the polyethylene ranges between 0.1 and 3 wt %. If the top layer comprises nonpolar plastic film, especially polyolefin, the silicone proportion tends toward 0.1 wt % because of the low chemical affinity of the film surface. If the top layer comprises polar plastic film, especially polyvinyl chloride (PVC), polyethylene terephthalate (PET), polycarbonate (PC), polystyrene (PS), the silicone proportion tends toward 3 wt % because of the higher chemical affinity of the film surface and the strong chemical bonding forces. The mixing ratio must be adapted to the material and to the surface texture (smooth/rough/glossy/dull) of the top layer and to the strength of the desired adhesion, taking into consideration the respective extrusion conditions.

A method for making the inventive laminate comprises drawing off webs of backing material and top material from one coil each, uniting them on a cooling cylinder with pressure roll, extruding the adhesive therebetween and, after the laminate has traveled around part of the circumference of the cooling cylinder, guiding it away therefrom and winding it on a coil.

Either the adhesive can be monoextruded through a broad slot, or the adhesive together with polyolefin, preferably LD polyethylene, can be coextruded through a broad slot.

### BRIEF DESCRIPTION OF THE DRAWINGS

The invention will be explained in more detail hereinafter with reference to practical examples illustrated in the drawing, wherein:

FIG. 1 shows the diagram of a system for making a laminate;

FIG. 2 schematically shows, not to scale, the structure of a laminate with a monoextruded adhesive layer; and

FIG. 3 schematically shows, not to scale, the structure of a laminate with a coextruded adhesive layer.

### DETAILED DESCRIPTION OF THE PREFERRED EMBODIMENTS

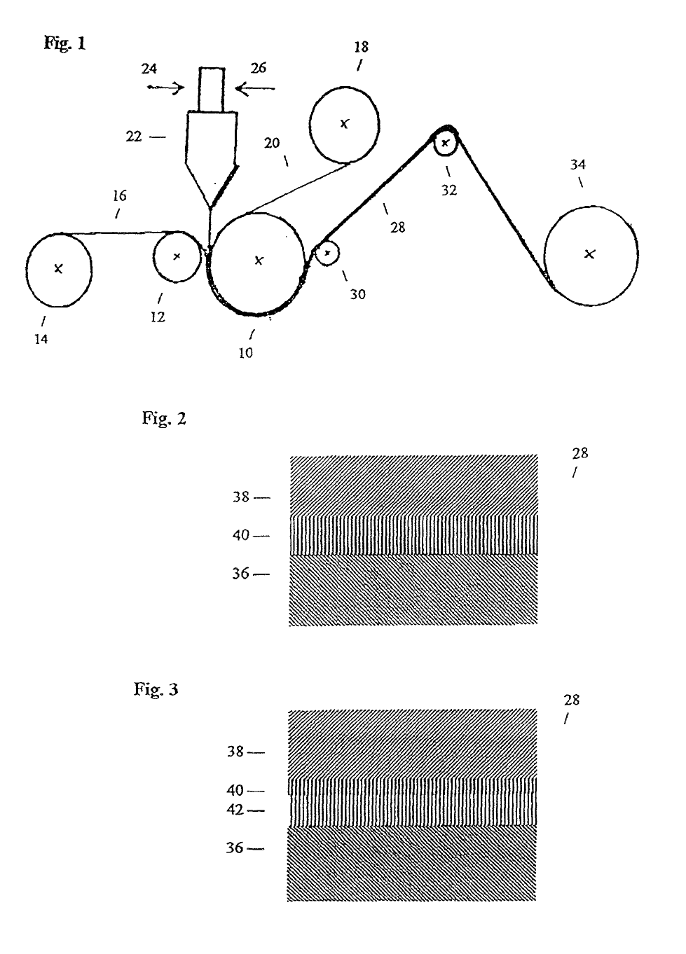

FIG. 1 shows a laminator with a cooling cylinder 10 and a pressure roll 12. A web of backing material 16 is drawn off from a first coil 14. A web of top material 20 is drawn off from a second coil 18. Webs 16, 20 are united at the gap between cooling cylinder 10 and pressure roll 12 and are laminated together by broad-slot coextrusion.

LD polyethylene 24 is fed to coextruder 22 on the side facing backing layer 16, and a mixture 26 of LD polyethylene and silicone-grafted LD polyethylene is fed on the side facing top layer 20.

After laminate 28 has traveled over approximately half of the circumference of cooling cylinder 10, it is guided away therefrom over rolls 30, 32 and wound onto a coil 34.

FIG. 2 shows a laminate 28 with a backing layer 36, a top layer 38 and, monoextruded therebetween, an adhesive layer 40, which comprises a mixture 26 of LD polyethylene and silicone-modified LD polyethylene.

FIG. 3 shows a laminate 28 with a backing layer 36, a top layer 38 and, coextruded therebetween, an adhesive layer, which is formed from a relatively thick base layer 42 of LD polyethylene facing backing layer 36 and from a relatively thin adhesive layer 40, which faces top layer 38 and which comprises a mixture 26 of LD polyethylene and silicone-modified LD polyethylene.

### EXAMPLE

Backing layer 36 is made of paper. Top layer 38 is made of OPP film (oriented polypropylene film) of 60μ thickness. The silicone proportion of modified LD polyethylene 26 is 0.15 to 0.6 wt %. Adhesive layer 40 cannot be detached from backing layer 36 without damage. Its adhesion to top layer 38 is 2 to 16 N/m in the peeling test at a pull-off angle of 180° and a travel speed of 300 mm/min.

What is claimed is:

1. A separable adhesive layer made by extrusion lamination and comprising a mixture of silicone-modified polyethylene and adhesive polyolefin.

2. A layer according to claim 1, characterized in that the polyethylene is low-density polyethylene.

3. A layer according to claim 1, characterized in that the polyethylene is grafted with the silicone.

4. A layer according to claim 1, characterized in that the polyethylene is mixed with the silicone.

5. A layer according to one of claim 1, characterized in that it is monoextruded.

6. A layer according to claim 1, characterized in that it is coextruded with polyolefin, preferably low density polyethylene.

7. A layer according to claim 6, wherein said polyolefin is low density polyethylene.

8. A laminate with a backing layer and a top layer, which are laminated together with an adhesive layer extruded therebetween, characterized in that the adhesive comprises a mixture of silicone-modified polyethylene and adhesive polyolefin.

9. A laminate according to claim 8, characterized in that the polyethylene is LD polyethylene.

10. A laminate according to claim 8, characterized in that the polyethylene is grafted with the silicone.

11. A laminate according to claim 8, characterized in that the polyethylene is mixed with the silicone.

12. A laminate according to claim 8, characterized in that the backing layer is made of a member selected from the group consisting of paper, especially high-density, smooth paper, plastic-coated paper, plastic film and a combination thereof.

13. A laminate according to claim 8, characterized in that the top layer is made of a manner selected from the group consisting of special paper which is resistant to surface splitting, plastic-coated paper, plastic film and a combination thereof.

14. A laminate according to claim 8, characterized in that the silicone proportion of the polyethylene ranges between 0.1 and 3 wt %.

15. A laminate according to claim 8, characterized in that the top layer comprises a nonpolar plastic film, and in that the silicone proportion of the polyethylene tends toward 0.1 wt %.

16. A laminate according to claim 15, wherein said nonpolar plastic film comprises polyolefin.

17. A laminate according to claim 8, characterized in that the top layer comprises polar plastic film, polyvinyl chloride, polyethylene terephthalate, polycarbonate, polystyrene, and in that the silicone proportion of the polyethylene tends toward 3 wt %.

18. A laminate according to claim 17, wherein said polar plastic film is a member selected from the group consisting of polyvinyl chloride, polyethylene terephthalate, polycarbonate, polystyrene, and a combination thereof.

19. A laminate according to claim 8, characterized in that the adhesive layer is monoextruded.

20. A laminate according to claim 19, characterized in that the monoextruded adhesive material is 10 to 40μ thick.

21. A laminate according to claim 8, characterized in that the adhesive layer is coextruded with polyolefin.

22. A laminate according to claim 21, wherein said polyolefin is low density polyethylene.

23. A laminate according to claim 21, characterized in that, in the coextruded material, the polyolefin is 10 to 30μ thick and the adhesive is 1 to 10μ thick.

24. A laminate according to claim 23, characterized in that the adhesive faces the top layer.

25. A method for making the laminate according to claim 8, characterized in that webs of backing material and top material are drawn off from one coil each and united on a cooling cylinder with pressure roll the adhesive is extruded therebetween and, after the laminate has traveled around part of the circumference of the cooling cylinder, it is guided away therefrom and wound on a coil.

26. A method according to claim 25, characterized in that the adhesive is monoextruded through a broad slot.

27. A method according to claim 25, characterized in that the adhesive together with polyolefin, is coextruded through a broad slot.

28. A method according to claim 25, wherein said polyolefin is low density polyethylene.
